(19) United States
(12) Patent Application Publication
(10) Pub. No.: US 2024/0289679 A1
(43) Pub. Date: Aug. 29, 2024

(54) Modeling Exponentially Large Classical Physical Systems using Quantum Computing

(71) Applicant: Google LLC, Mountain View, CA (US)

(72) Inventor: Rolando D. Somma, Santa Fe, NM (US)

(21) Appl. No.: 18/585,743

(22) Filed: Feb. 23, 2024

Related U.S. Application Data
(60) Provisional application No. 63/486,537, filed on Feb. 23, 2023.

(51) Int. Cl. G06N 10/80; G06N 10/20; G06N 10/40; G06N 10/60

(52) U.S. Cl. CPC G06N 10/80; G06N 10/20; G06N 10/40; G06N 10/60

(57) ABSTRACT

Systems and methods for simulating classical physical systems are provided. In one example, a method may include initializing one or more qubits with an initial quantum state encoding one or more physical properties of a classical physical system comprising an oscillator network. An example method may include simulating, by one or more quantum computing devices using the one or more qubits, the classical physical system.

### CROSS-REFERENCE TO RELATED APPLICATIONS

The present application is based upon and claims the right of priority to U.S. Provisional Patent Application No. 63/486,537, filed on Feb. 23, 2023, the disclosure of which is hereby incorporated by reference herein in its entirety for all purposes.

### FIELD

The present disclosure relates generally to systems and methods for quantum computing.

### BACKGROUND

Quantum computing is a computing method that takes advantage of quantum effects, such as superposition of basis states and entanglement to perform certain computations more efficiently than a classical digital computer. In contrast to a digital computer, which stores and manipulates information in the form of bits, e.g., a “1” or “0,” quantum computing systems can manipulate information using quantum bits (“qubits”). A qubit can refer to a quantum device that enables the superposition of multiple states, e.g., data in both the “0” and “1” state, and/or to the superposition of data, itself, in the multiple states. In accordance with conventional terminology, the superposition of a “0” and “1” state in a quantum system may be represented, e.g., as a|0 [symbol] +b|1 [symbol] The “0” and “1” states of a digital computer are analogous to the |0 [symbol] and |1 [symbol] basis states, respectively of a qubit.

### SUMMARY

Aspects and advantages of embodiments of the present disclosure will be set forth in part in the following description, or can be learned from the description, or can be learned through practice of the embodiments.

Example aspects of the present disclosure provide an example method. In some implementations, the example method can include encoding one or more first properties of a classical physical system in a state of one or more qubits. In the example method, the classical physical system can include an oscillator network. The example method can include simulating, by one or more quantum computing devices using the one or more qubits, the classical physical system.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example system of generalized harmonic oscillators according to example aspects of the present disclosure;

FIG. 2 depicts an example generalized waveform according to example aspects of the present disclosure;

FIG. 3 depicts an example of a quantum computing system according to example aspects of the present disclosure;

FIG. 4 depicts a flowchart diagram of an example quantum computing method according to the present disclosure;

FIG. 5 depicts a flowchart diagram of an example quantum computing method according to example aspects of the present disclosure;

FIG. 6 depicts a block diagram of an example computing system according to example aspects of the present disclosure.

### DETAILED DESCRIPTION

### Overview

Example embodiments according to some aspects of the present disclosure are directed to systems and methods for efficiently simulating classical physical systems using quantum computing. More particularly, systems and methods according to examples of the present disclosure can simulate a wide variety of classical physical systems (e.g., electromagnetic waves, acoustic waves, molecular vibrations, etc.) that can be modeled using a harmonic approximation. A harmonic approximation can include, for example, approximating a classical physical system as a system of harmonic oscillators, which can be mathematically analogous to a system of interconnected mass-and-spring oscillators. In some instances, systems and methods of the present disclosure can compute some properties of a classical physical system in a time that is logarithmic with respect to a size of the classical physical system. In this manner, for instance, methods of the present disclosure can model some classical physical systems that are exponentially large in relation to a complexity of a quantum computation used to model the system.

Example methods can include, for example, initializing a plurality of qubits in an initial quantum state that encodes physical properties of the classical physical system at a first time. Example methods can include simulating time evolution of a Hamiltonian to generate a second quantum state that encodes physical properties of the classical physical system at a second time. Example methods can include, for example, measuring an observable associated with the second quantum state, wherein the observable corresponds to a property of interest associated with the classical physical system at the second time.

An initial quantum state can encode, for example, physical properties associated with one or more generalized momenta and generalized displacements (e.g., relative to a rest position) of a harmonic approximation of the classical physical system. Generalized properties of the harmonic approximation can be, for example, properties that are mathematically analogous (e.g., mathematically equivalent to) a corresponding property of a spring-and-mass oscillator system corresponding to the harmonic approximation of the classical physical system. For example, a generalized oscillating mass of a spring-and-mass approximation can have a generalized mass, generalized position, generalized momentum, generalized velocity, etc. A spring of a spring-and-mass approximation can have, for example, a generalized spring constant. As a non-limiting illustrative example, an electrical circuit such as a series resistor-inductor-capacitor (RLC) circuit can generate an output waveform that corresponds to a harmonic oscillator, which can be mathematically analogous to a spring-and-mass oscillator. In such a circuit, a charge can correspond to a generalized position of an oscillating mass; a current can correspond to a generalized velocity; an inductance can correspond to a generalized mass; and so on.

In some instances, a method for encoding the initial quantum state can have a complexity that is logarithmic in relation to a size of the classical physical system being encoded. For example, in some instances, a classical physical system or harmonic approximation can be characterized by sparse connections between generalized oscillating masses. For example, each oscillating mass may be connected to only d other oscillating masses, wherein d can be a constant. Such systems can be referred to as “d-sparse” systems. In such instances, a variety of efficient coding implementations are possible. Some example encoding implementations are further described below and in U.S. Provisional App. No. 63/486,537, incorporated by reference herein.

In some instances, time evolution of a Hamiltonian can be based on a Hamiltonian configured to correspond to time evolution of the classical physical system or a harmonic approximation thereof. In some instances, the Hamiltonian can be constructed in a time that is logarithmic with respect to a size of the classical physical system, and its evolution can be simulated in a time that is logarithmic with respect to a size of the classical physical system. For example, in some instances where a classical physical system (or harmonic approximation) is d-sparse, a unitary can be provided that receives an index j indicative of a particular oscillating mass, and efficiently returns one or more of: a generalized mass of the oscillating mass; one or more of d non-zero spring constants associated with the oscillating mass; and one or more indices k associated with respective oscillating masses connected to a j^{th} oscillating mass by respective springs having non-zero spring constants. In such instances, a Hamiltonian can be efficiently constructed based on outputs of the provided unitary, and its evolution can be efficiently simulated according to known methods. In some instances, a complexity of the simulation can also be sublinear with respect to d. Example implementation details are further described below and in U.S. Provisional App. No. 63/486,537, incorporated by reference herein.

In some instances, the property measured can be a global property of the classical physical system as a whole, which can in some instances be measured in a time that is logarithmic in relation to a size of the classical physical system. For example, in some instances, provided methods can efficiently estimate a generalized kinetic energy associated with an entire classical physical system as a whole. In some instances, a physical property of a subset of the classical physical system can be measured. For example, a subset of the generalized oscillating masses of a harmonic approximation can be identified, and a generalized kinetic energy of the subset can be efficiently measured. Other example properties are possible (e.g., potential energy, etc.).

In some instances, a classical physical system can be simulated a plurality of times to generate a plurality of measurements. In some instances, a number of times to simulate the classical physical system can be selected based on a target precision ϵ. For example, in some instances, a target error probability δ and a target additive error ϵ can be obtained. In such instances, a generalized physical property of interest can be estimated efficiently with a quantum algorithm that makes O(|log δ|/ϵ) uses of the quantum circuits that simulate and measure the classical physical system. In some instances, a number of times to simulate the classical physical system can be selected according to known statistical methods (e.g., classical statistical methods).

In some instances, systems and methods according to examples of the present disclosure can be BQP-complete, meaning that any problem in the class of bounded-error quantum polynomial time (BQP) problems can be mapped to a harmonic approximation of a classical system of the present disclosure, and vice versa. In this manner, for instance, other BQP problems (e.g., other quantum algorithms) can be mapped to a harmonic approximation of a classical system and efficiently solved according to provided systems and methods. Additionally, provided systems and methods can in some instances enable simulating a quantum algorithm of the BQP class using existing methods for simulating systems of harmonic oscillators. For example, a BQP quantum problem can be mapped to a quantum computation of the present disclosure; the quantum computation of the present disclosure can be mapped to a system of classical harmonic oscillators; and the system of harmonic oscillators can be simulated according to classical methods (e.g., classical computing devices, etc.). Although a complexity of such classical simulations may in some instances be exponentially large in relation to a complexity of a corresponding quantum computation, such a classical simulation can still be useful in some instances (e.g., small to medium problem sizes, etc.). For example, a classical computing system can in some instances have technical advantages over a corresponding quantum computing system, such as reduced noise, reduced computational cost (e.g., on a per-bit or per-qubit basis), etc. In such instances, classical simulation of a BQP problem may be useful for some purposes (e.g., error rate benchmarking, etc.), even in instances where the classical simulation is associated with a high computational complexity in relation to a problem size.

Example embodiments according to some aspects of the present disclosure can provide for a number of technical effects and benefits, such as improvements to computing technology (e.g., quantum computing technology). For example, systems and methods of the present disclosure can simulate classical physical systems more efficiently than alternative methods such as classical computing simulations. For example, in some instances, a complexity associated with systems and methods of the present disclosure can be logarithmic in relation to a size of the classical physical system being simulated. In this manner, for instance, a classical physical system can be exponentially large in relation to a complexity of example quantum computations of the present disclosure. In contrast, alternative methods (e.g., classical computing methods) can in some instances require at least a linear complexity in relation to a size of the classical physical system. Thus, alternative methods may be associated with a complexity that is exponentially large compared to provided systems and methods.

In some instances, an exponential speedup associated with systems and methods of the present disclosure may enable tasks that can be difficult and/or significantly non-trivial to practically perform using a classical computing system. For example, tasks having exponential complexity can become practically impossible when a problem size becomes too large, even if the task is easy at small problem sizes. For example, a 256-bit RSA encryption can be decrypted (“cracked”) in under one minute through brute force computation, but a problem only eight times as large (2048-bit RSA encryption) can take trillions or quadrillions of years to decrypt using present-day classical computers. In contrast, a system or method having non-exponential complexity can in some instances scale to large problem sizes more efficiently. As one illustrative example, if a system or method has a polynomial complexity of O(n²) and can perform a small computation in under one minute, then the same system or method may perform a computation eight times larger in approximately sixty-four minutes rather than quadrillions of years. Thus, systems and methods of the present disclosure may in some instances enable classical computing that can be difficult to perform without quantum methods.

Although this disclosure describes some activities that can be performed in a logarithmic time in relation to a classical physical system, systems and methods with non-logarithmic efficiency can be used without going outside the scope of the present disclosure. For example, in some instances, a quantum computation of the present disclosure can simulate a classical physical system having a size that is polynomial with respect to a complexity of the quantum computation without going outside the scope of the present disclosure.

With reference now to the Figures, example embodiments of the present disclosure will be discussed in further detail.

### Example Harmonic Approximations

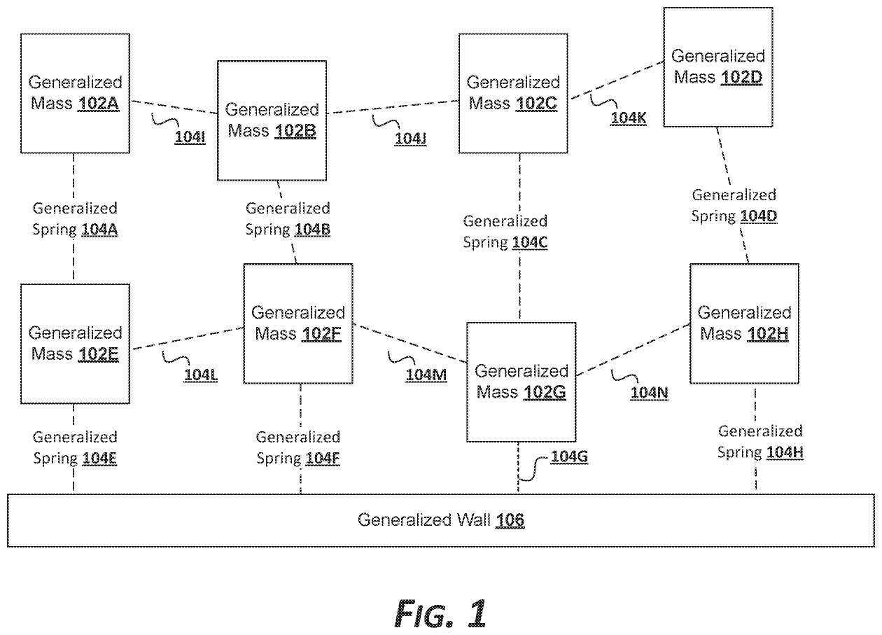

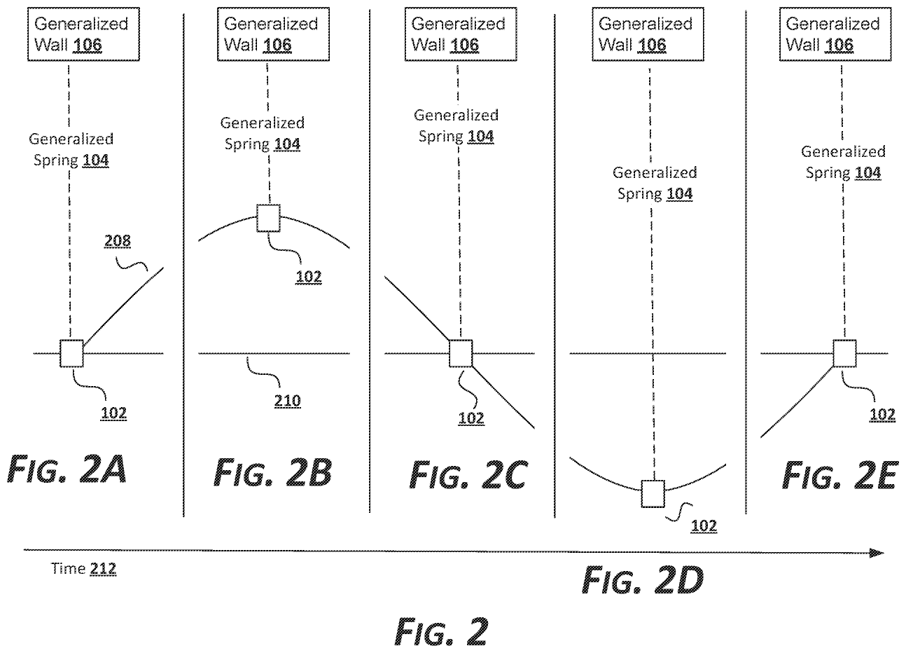

FIG. 1 depicts an example harmonic approximation, wherein a classical physical system can be modeled as an oscillator network comprising a plurality of generalized oscillating masses. Harmonic approximation can include, for example, mapping a classical physical system to a corresponding system of harmonic oscillators, which can comprise generalized oscillating masses 102, generalized springs 104, and generalized walls 106. Generalized oscillating masses 102A-H can be attached to each other and/or one or more generalized walls 106 via one or more generalized springs 104A-N. A variety of classical physical systems (e.g., molecular vibration, thermal expansion, various systems comprising waves, etc.) can be modeled or approximated according to the depicted harmonic approximation. Further examples of harmonic approximation are depicted below with respect to FIG. 2.

A generalized oscillating mass 102 can comprise, for example, an oscillating mass of a harmonic approximation, wherein the generalized oscillating mass 102 is configured to be mathematically analogous (e.g., equivalent to, approximated by, etc.) to a component or property of the classical physical system. A generalized oscillating mass 102 can have, for example, a plurality of generalized properties, including but not limited to a generalized position; a generalized mass property; and a generalized momentum. Each generalized property can, for example, be configured to be mathematically analogous to (e.g., equivalent to, approximated by, etc.) a corresponding physical property of the classical physical system and mathematically analogous to (e.g., equivalent to, etc.) a corresponding physical property of an oscillating mass in a system of mass-and-spring harmonic oscillators. For example, a generalized velocity can be a rate of change of a generalized position; a generalized momentum can be a product of a generalized mass and a generalized velocity; and a generalized mass of an oscillating mass 102 can be indicative of an amount of generalized force needed to accelerate or decelerate a generalized oscillating mass 102 at a particular rate. As a non-limiting illustrative example, a series resistor-inductor-capacitor (RLC) circuit can generate an output waveform that corresponds to a harmonic oscillator, wherein a charge can correspond to a generalized position of an oscillating mass; a current can correspond to a generalized velocity; an inductance can correspond to a generalized mass; and so on. As another example, a parallel RLC circuit can generate a different output waveform corresponding to a different harmonic oscillator, wherein a flux linkage can correspond to a generalized position; a voltage can correspond to a generalized velocity; a capacitance can correspond to a generalized mass; and a charge can correspond to a generalized momentum.

A generalized spring 104 can be, for example, a spring associated with a harmonic approximation, wherein the generalized spring 104 is configured to be mathematically analogous to (e.g., equivalent to, approximated by, etc.) a component or property of the classical physical system. A generalized spring 104 can have, for example, a plurality of generalized properties, including but not limited to a generalized spring constant and a generalized displacement (e.g., generalized distance compressed or stretched relative to a generalized rest position). For example, a generalized spring constant of a generalized spring 104 can correspond to a ratio between a force applied by the generalized spring 104 and a generalized displacement (e.g., generalized distance compressed or stretched) of the generalized spring 104 relative to a generalized rest position. As a non-limiting illustrative example, a series resistor-inductor-capacitor (RLC) circuit can generate an output waveform that corresponds to a harmonic oscillator, wherein an elastance can correspond to a generalized spring constant of a generalized spring 104 corresponding to the series RLC circuit.

A generalized wall 106 can correspond, for example, to a generalized immovable object (e.g., having a generalized position that is fixed) associated with a harmonic approximation, wherein one or more generalized oscillating masses 102 can be attached to a generalized wall 106 via one or more generalized springs 104.

In general, a generalized oscillating mass 102, generalized spring 104, and generalized wall 106 can possess any generalized physical property (e.g., damping, drive force, etc.) corresponding to any physical property that a corresponding classical oscillating system can possess. In some instances, a generalized physical property of a generalized object 102, 104, 106 can be derived from other generalized physical properties of the generalized object 102, 104, 106 according to the laws of classical physics (e.g., Newton's laws). For example, a generalized kinetic energy of a generalized oscillating mass 102 can correspond to ½ mv², where m is a generalized mass value and v is a generalized velocity of the generalized oscillating mass 102. Similarly, a generalized elastic potential energy of a generalized spring 104 can correspond to ½κx², where κ can be a generalized spring constant and x can be a generalized displacement relative to a rest position of the generalized spring 104.

FIG. 2 depicts an example harmonic approximation of a waveform 208, wherein a generalized displacement of the waveform 208 with respect to time can be modeled as or mapped to a system of harmonic oscillator(s). A variety of classical physical waveforms can be harmonically approximated in a manner similar to (e.g., same as) the manner depicted, including but not limited to acoustic waves; light waves; electromagnetic waves; etc.

In FIG. 2, the waveform 208 is depicted as a curve that can oscillate continuously over time 212 about a center point 210. FIGS. 2A-E depict an example generalized oscillator 102, generalized spring 104, and generalized wall 106 at five discrete time points associated with the waveform 208. At the first time point, depicted in FIG. 2A, the generalized oscillator 102 and generalized spring 204 can have a displacement of zero relative to a generalized rest position 210 of the generalized spring 204, and the generalized oscillator 102 can have a positive generalized velocity, wherein the generalized oscillator 102 can be moving toward the wall. In some instances, the generalized rest position 210 can correspond to the center point 210 of the waveform 208. During the time period between FIG. 2A and FIG. 2B, the generalized spring 204 can decelerate the generalized oscillating mass 102, wherein a generalized force of deceleration can be proportional to a displacement (e.g., compression) of the generalized spring 104 relative to the rest position 210. At time 2B, a generalized velocity of the generalized oscillating mass 102 can be zero relative to the generalized wall 106, and the generalized spring 204 can continue to accelerate the generalized mass 102 in a negative direction, away from the generalized wall 106. At time 2C, a generalized velocity of the generalized oscillating mass can have a similar (e.g., same) magnitude and opposite sign relative to time 2A. In other respects, some physical properties (e.g., generalized displacement, generalized force or acceleration, etc.) of the depicted harmonic approximation at time 2C can be similar (e.g., same) compared to time 2A. At time 2D, some properties (e.g., generalized displacement, generalized force, generalized acceleration) of the harmonic approximation can have a similar (e.g., same) magnitude and opposite sign relative to time 2B. In other respects, some physical properties (e.g., generalized velocity of zero, etc.) of the depicted harmonic approximation at time 2D can be similar (e.g., same) compared to time 2B. FIG. 2E depicts a state of the generalized oscillating mass 102, generalized spring 104, and generalized wall 106, which can in some instances be identical to a state depicted in FIG. 2A (e.g., when time 2A and 2E are exactly one period apart).

In some instances, a waveform 208 can be a generalized waveform 208 representing an approximation of a different (e.g., non-wave-based) classical physical system. In some instances, a harmonic approximation can be reversible. For example, in some instances a waveform 208 can be approximated as one or more oscillators, and a system of one or more oscillators can be approximated as a generalized waveform 208.

Although FIG. 2 depicts a relatively simple example comprising a sinusoidal waveform corresponding to a single generalized oscillating mass 102, more complex waves (e.g., multi-dimensional waves, waveforms having a plurality of higher-order harmonics, etc.) can be modeled in a similar (e.g., same) way.

### Example Quantum Simulations

In general, quantum simulation of a classical physical system can comprise initializing one or more qubits with a quantum state encoding one or more properties of the physical system. In some instances, the properties of the classical physical system can be, comprise, or be associated with generalized properties of a harmonic approximation of the classical physical system. Quantum simulation can further include simulating, by a quantum computing system using the one or more qubits, the classical physical system. In some instances, simulating can comprise simulating time evolution of a Hamiltonian. Quantum simulation can further include, for example, measuring one or more observables associated with the one or more qubits. In some instances, the observables can be associated with a final state of the one or more qubits after simulating time evolution of the Hamiltonian.

### Example Quantum States Encoding Classical Physical Properties

Quantum simulation of a classical physical system can comprise initializing one or more qubits with a quantum state encoding one or more properties of the classical physical system (e.g., properties of a harmonic approximation of the classical physical system). In some instances, the one or more properties can comprise generalized momenta or generalized velocities and generalized displacements or generalized positions associated with one or more generalized oscillating masses 102.

In some instances, an initial quantum state encoding generalized momenta or generalized velocities and generalized displacements or generalized positions can be described by the equation

$$\vert ψ ( t ) 〉 = \frac{1}{\sqrt{2 E}} ( \begin{matrix}{M}^{\frac{1}{2}} \dot{\vec{x}} ( t ) \\ i \vec{μ} ( t )\end{matrix} ) ,$$

where E can be a constant greater than zero; i can be the square root of −1; M can be an N×N diagonal matrix of generalized mass values associated with N generalized oscillating masses 102;

$${M}^{\frac{1}{2}}$$

can be a matrix square root of M; \vec{\dot{x}}(t) can be a vector of N generalized velocities of the N generalized oscillating masses 102 at time t; \vec{μ}(t) can be a vector having N(N+1)/2 real-valued entries, wherein each entry can be written as either \sqrt{κⱼⱼ}xⱼ(t) or \sqrt{κⱼₖ}(xⱼ(t)−xₖ(t)) where k>j, κⱼₖ is a generalized spring constant of a generalized spring 104 between a j^{th} and k^{th} generalized oscillator 102, and κⱼⱼ is a generalized spring constant of a generalized spring 104 between a j^{th} generalized oscillator 102 and a generalized wall 106. In some instances, a time t associated with the initial quantum state can be zero.

In some instances, E can be equal to K(t)+U(t), where K(t) can be a generalized kinetic energy associated with the classical physical system at time t (e.g., generalized kinetic energy of a plurality of generalized oscillating masses 102) and U(t) can be a generalized potential energy associated with the classical physical system at time t. In this manner, for instance, E can be a generalized total energy of the classical physical system, which can be constant over time.

In some instances, an initial quantum state can encode other properties of the classical physical system, instead of or in addition to generalized momenta and displacements. For example, a generalized kinetic energy K(t) at time t can be written, for example, as

$$\frac{1}{2} {\dot{\vec{x}} ( t )}^{T} M \dot{\vec{x}} ( t ) ,$$

which can correspond to a sum over all generalized oscillating masses 102 of mv², where v is a generalized velocity of a respective generalized oscillating mass 102 and m is a generalized mass value of a respective generalized oscillating mass 102. In this manner, for instance, an initial state |ψ(0) [symbol] can encode a generalized kinetic energy K(0) of the classical physical system. Similarly, a potential energy U(t) at time t can be written, for example, as

$$\frac{1}{2} {\vec{μ} ( t )}^{T} \vec{μ} ( t ) .$$

In this manner, for instance, an initial state |ψ(0) [symbol] can encode a generalized potential energy of the harmonic approximation of the classical physical system.

In some instances, an initial quantum state |ψ(0) [symbol] encoding generalized momenta and generalized displacements can be encoded in an amount of time that is logarithmic in relation to a number of generalized oscillators 102 being encoded. For example, in some instances, one or more concise representations of K and M can enable accessing any entry of K or M in a time that is sublinear (e.g., constant) in relation to a number N of generalized oscillating masses 102 associated with a classical physical system. In some instances, K can be a d-sparse matrix of generalized spring constants κⱼⱼ associated with generalized springs 104 connecting a j^{th} generalized oscillating mass 102 to a generalized wall 106 and spring constants κⱼₖ associated with generalized springs 104 connecting a j^{th} generalized oscillating mass 102 to a k^{th} generalized oscillating mass 102. In some instances, concise representations of M can include functions that receive an oscillator index j as input and generate an M entry mⱼ as output, wherein mⱼ can correspond to a mass of the j^{th} generalized oscillating mass 102 associated with a classical physical system. In some instances, such a function can be implemented in a quantum circuit (e.g., comprising one or more quantum gates) to provide access to any value mⱼ given an oscillator index j. In some instances, this access can be referred to as “oracle access.” Similarly, in some instances (e.g., when K is d-sparse), concise representations of K can include functions that receive an oscillator index j as input and return one or more non-zero generalized spring constants κⱼⱼ and κⱼₖ associated with a j^{th} generalized oscillating mass 102.

Similarly, in some instances, one or more concise representations of \vec{\dot{x}}(0) and \vec{x}(0) can enable accessing any entry of \vec{\dot{x}}(0) or \vec{x}(0) in a time that is sublinear (e.g., constant or logarithmic) in relation to a number N of generalized oscillating masses 102 associated with a classical physical system. In instances where concise representations of \vec{\dot{x}}(0), \vec{x}(0), K and M are available, an initial state |ψ(0) [symbol] encoding generalized momenta and displacements of the classical physical system at time zero can be initialized efficiently (e.g., in logarithmic time relative to a size of the classical physical system). For example, in some instances, a unitary S can be provided that computes the masses mⱼ on input j and the nonzero entries of K, i.e. κⱼₖ, on input (j, k), as well as their locations. For example, one or more unitaries S can be provided to perform the maps

|j,l [symbol] →|j,a(j,l) [symbol] ,

|j,k,z [symbol] =→|j,k,z⊕κⱼₖ [symbol] ,

|j,z [symbol] →|j,z⊕mⱼ [symbol] ,

where j and k can be any number between 1 and N; l can be any number between 1 and d, where K is d-sparse; and a(j, l) can be the column index of the l^{th} nonzero entry in the j^{th} row of K.

In some instances, a unitary U can be provided that efficiently prepares |\vec{x}(0) [symbol] and |\vec{\dot{x}}(0) [symbol] . Given U and S, an initial state |ψ(0) [symbol] can be efficiently prepared by making calls to U, S, their inverses and other gates.

For example, in some instances, an initial state |ψ(0) [symbol] can be prepared by applying matrices

$${M}^{\frac{1}{2}}$$

and

$${B}^{†} {M}^{\frac{1}{2}}$$

via quantum walks, wherein B^{†} can be a Hermitian adjoint of B and B can be (\vec{b}₁₁, \vec{b}₁₂, . . . , \vec{b}_{1N}, \vec{b}₂₂, \vec{b}₂₃, . . . , \vec{b}_{2N}, . . . , \vec{b}_{N-1N}, \vec{b}_{NN}), where

$${\vec{b}}_{jj} = \sqrt{\frac{{κ}_{jj}}{{m}_{j}}} {\vec{e}}_{j} and {\vec{b}}_{jk} = \sqrt{{κ}_{jk}} ( \frac{{\vec{e}}_{j}}{\sqrt{{m}_{j}}} - \frac{{\vec{e}}_{k}}{\sqrt{{m}_{k}}} ) for 1 \leq j < k < N ,$$

where \vec{e}ⱼ can be a canonical vector having a 1 in the j^{th} position and a zero in all other positions.

In some instances, a unitary U can perform the map

$$\vert 0 〉 \to \vert 0 〉 \vert \dot{\vec{x}} ( 0 ) 〉 ,$$

$$\vert 1 〉 \to \vert 1 〉 \vert \vec{x} ( 0 ) 〉 ,$$

$$where$$

$$\vert \dot{\vec{x}} ( 0 ) 〉 = \frac{1}{α} {\sum }_{j = 1}^{N} {\dot{x}}_{j} ( 0 ) \vert j 〉 ,$$

$$\vert \vec{x} ( 0 ) 〉 = \frac{1}{β} {\sum }_{j = 1}^{N} {x}_{j} ( 0 ) \vert j 〉$$

can be normalized states that encode the initial states of the generalized oscillating masses 102 in their amplitudes, and where α>0 and β>0 can also be known. In such instances, an initial state that is ϵ-close to

$$\vert ψ ( 0 ) 〉 = \frac{1}{\sqrt{2 E}} ( \begin{matrix}{M}^{\frac{1}{2}} \dot{\vec{x}} ( 0 ) \\ i \vec{μ} ( 0 )\end{matrix} )$$

can be generated by calling U, S, their inverses, and two-qubit gates.

For example, in some instances, an initial state ϵ-close to |ψ(0) [symbol] can be generated by performing two preparation actions. A first preparation action can prepare a state |ϕ [symbol] using one call to the unitary U and O(1) two-qubit gates, as follows:

$$\vert 0 〉 \to \frac{1}{{( m {α}^{2} + {d}^{2} κ {β}^{2} )}^{\frac{1}{2}}} ( {m}^{\frac{1}{2}} a \vert 0 〉 + id \sqrt{k} β \vert 1 〉 ) \to \frac{1}{{( m {α}^{2} + {d}^{2} κ {β}^{2} )}^{\frac{1}{2}}} ( {m}^{\frac{1}{2}} a \vert \dot{\vec{x}} ( 0 ) 〉 + id \sqrt{k} β \vert \vec{x} ( 0 ) 〉 ) .$$

A second preparation action can transform |ϕ [symbol] so that its amplitudes match those of |ψ(0) [symbol] , which can be written as

$$\vert ψ ( 0 ) 〉 = \frac{1}{\sqrt{2 E}} ( \begin{matrix}{M}^{\frac{1}{2}} \dot{\vec{x}} ( 0 ) \\ {iB}^{†} {M}^{\frac{1}{2}} \vec{x} ( 0 )\end{matrix} ) .$$

The second preparation action can be performed, for example, by constructing a unitary

$$V = ( \begin{matrix}\frac{1}{{m}^{\frac{1}{2}}} {M}^{\frac{1}{2}} & 0 & 0 \\ 0 & 0 & \frac{1}{d \sqrt{κ}} C \\ 0 & \frac{1}{d \sqrt{κ}} C & 0\end{matrix} ) ,$$

wherein

$$C := {M}^{\frac{1}{2}} B$$

and acting on |ϕ [symbol] with the unitary V. In some instances, a unitary V can be constructed according to known methods based on block encodings and quantum walks. Additional example implementation details are further described in U.S. Provisional App. No. 63/486,537, incorporated by reference herein.

In some instances, other encodings can be used to encode one or more properties of the classical physical system in a quantum state of one or more qubits. Example alternate encodings are further described below, after discussion of example Hamiltonians. (The example alternate encodings described below are based in part on matrices discussed with respect to example Hamiltonians below, and are therefore more easily understood in light of the example Hamiltonians.)

### Example Hamiltonians for Simulating Time Evolution

Quantum simulation of a classical physical system can comprise simulating time evolution of a Hamiltonian using the one or more qubits. In some instances, the Hamiltonian can be configured to simulate time evolution of the classical physical system.

In some instances, an appropriate Hamiltonian can be determined efficiently from K and M. For example, Newton's equation for the dynamics of classical harmonic oscillators can be written, in matrix form, as

M\vec{\ddot{x}}(t)=−F\vec{x}(t),

where F is an N×N matrix whose diagonal and off-diagonal entries are fⱼⱼ=Σₖκⱼₖ and fⱼₖ=−κⱼₖ. The above equation can also be written as

\vec{\ddot{y}}(t)=−A\vec{y}(t),

where

$$A = {M}^{- \frac{1}{2}} {FM}^{- \frac{1}{2}} .$$

This can also be written as

$$\ddot{\vec{y}} ( t ) + {iA}^{\frac{1}{2}} \dot{\vec{y}} ( t ) = {iA}^{\frac{1}{2}} ( \dot{\vec{y}} ( t ) + {iA}^{\frac{1}{2}} \vec{y} ( t ) ) ,$$

which is equivalent to Schrodinger's equation induced by a Hamiltonian

$$- {A}^{\frac{1}{2}} .$$

Thus, a Hamiltonian comprising a matrix square root of A can be used to simulate time evolution of a harmonic approximation comprising one or more generalized oscillating masses 102 and one or more generalized springs 104.

In some instances, a Hamiltonian comprising a matrix square root of A can be determined from an N×M matrix B satisfying BB^{†}=A, where B^{†} is the Hermitian adjoint of B. For example, a Hamiltonian H can be written as

$$H := - ( \begin{matrix}0 & B \\ {B}^{†} & 0\end{matrix} ) .$$

In this manner, for instance, H can act on the space on the space [symbol] ^{N+M} and can have a square H² whose first block is A. In this manner, for instance, a Hamiltonian H whose square comprises A can function as a Hamiltonian comprising the “square root” of A. Schrodinger's equation induced by the Hamiltonian H can be written as |\dot{ψ}(t) [symbol] =−iH|ψ(t) [symbol] where |ψ(t) [symbol] is the state of the quantum system at time t.

In some instances, two subspaces according to the blocks of H can be considered separately, and Schrodinger's equation induced by the Hamiltonian H can be rewritten as

$$( \begin{matrix}\dot{\vec{v}} ( t ) \\ i \dot{\vec{μ}} ( t )\end{matrix} ) = ( \begin{matrix}- B \vec{μ} ( t ) \\ {iB}^{†} \vec{v} ( t )\end{matrix} ) ,$$

where \vec{v}(t) and i\vec{μ}(t) are the two components of |ψ(t) [symbol] .

In some instances, an initial state |ψ(0) [symbol] can be configured such that \vec{μ}(0)=B^{†}\vec{ϕ}(0) for some \vec{ϕ}(0)∈ [symbol] ^{N}. In such instances, an evolved state |ψ(t) [symbol] can satisfy \vec{μ}(t)=B^{†}\vec{ϕ}(t) for some \vec{ϕ}(t)∈ [symbol] ^{N}. In such instances, Schrodinger's equation induced by the Hamiltonian H can be rewritten as

$$\vert ψ ( i ) 〉 ∝ ( \begin{matrix}\dot{\vec{y}} ( t ) \\ {iB}^{†} \vec{y} ( t )\end{matrix} ) .$$

In this manner, for instance, a quantum computing system can simulate the dynamics of the classical oscillators by simulating a quantum system that evolves under H, with a proper initialization of |ψ(t) [symbol] .

In some instances, B can be (\vec{b}₁₁, \vec{b}₁₂, . . . , \vec{b}_{1N}, \vec{b}₂₂, \vec{b}₂₃, . . . , \vec{b}_{2N}, . . . , \vec{b}_{N-1N}, \vec{b}_{NN}), wherein

$${\vec{b}}_{jj} = \sqrt{\frac{{κ}_{jj}}{{m}_{j}}} {\vec{e}}_{j} and \\ {\vec{b}}_{jk} = \sqrt{{κ}_{jk}} ( \frac{{\vec{e}}_{j}}{\sqrt{{m}_{j}}} - \frac{{\vec{e}}_{k}}{\sqrt{{m}_{k}}} )$$

for 1≤j<k<N, where \vec{e}ⱼ can be a canonical vector having a 1 in the j^{th} position and a zero in all other positions. In some instances, B can be an N×M matrix, where M can be an integer greater than or equal to one. In some instances (e.g., with the choice of B described in this paragraph) each product \vec{b}ⱼₖ\vec{b}ⱼₖ^{T} can be a term of A=Σⱼₖ\vec{b}ⱼₖ\vec{b}ⱼₖ^{T}. In some instances, the vector

$$\vec{μ} ( t ) = {B}^{†} \vec{y} ( t ) = {B}^{†} {M}^{\frac{1}{2}} \vec{y} ( t )$$

can have entries equal to \sqrt{κⱼₖ}xⱼ(t) or \sqrt{κⱼₖ}(xⱼ(t)−xₖ(t)), which can correspond to the example quantum state encoding described above,

$$\vert ψ ( t ) 〉 = \frac{1}{\sqrt{2 E}} ( \begin{matrix}{M}^{\frac{1}{2}} \dot{\vec{x}} ( t ) \\ i \vec{μ} ( t )\end{matrix} ) .$$

In some instances, suitable Hamiltonians (e.g., the Hamiltonian H) can be constructed efficiently in a time logarithmic with respect to a size of the classical physical system. For example, in some instances, one or more concise representations of K and M can enable accessing any entry of K or M in a time that is sublinear (e.g., constant) in relation to a number N of generalized oscillating masses 102 associated with a classical physical system. In some instances, concise representations of M can include functions that receive an oscillator index j as input and generates an M entry mⱼ as output, wherein mⱼ can correspond to a mass of the j^{th} generalized oscillating mass 102 associated with a classical physical system. In some instances, such a function can be implemented in a quantum circuit (e.g., comprising one or more quantum gates) to provide access to any value mⱼ given an oscillator index j. In some instances, this access can be referred to as “oracle access.” Similarly, in some instances (e.g., when K is d-sparse), concise representations of K can include functions that receive an oscillator index j as input and return all non-zero generalized spring constants κⱼⱼ and κⱼₖ associated with a j^{th} generalized oscillating mass 102, in some instances (e.g., when K is d-sparse), concise representations of K can include functions that receive an oscillator index j as input and return one or more non-zero generalized spring constants κⱼⱼ and κⱼₖ associated with a j^{th} generalized oscillating mass 102. In instances where K is d-sparse, the Hamiltonian H can also be d-sparse. In some instances, entries

$${h}_{jk} = \pm \sqrt{\frac{{κ}_{jk}}{{m}_{j}}}$$

of the Hamiltonian H can be computed by determining κⱼₖ and mⱼ from a circuit providing efficient access (e.g., “oracle access”) to those values, and then computing hⱼₖ according to standard methods. In some instances where a unitary S provides a(j, l), b(j, l) can be easily computed from a(j, l), wherein b(j, l) can be the column index of the l^{th} nonzero entry in the j^{th} row of H.

Time evolution of the Hamiltonian H can be simulated according to existing methods. For example, in some instances, a method applying an approximation of the exponential e^{-itH} can be used, such as a truncated Taylor series. In some instances, such methods can achieve almost optimal scaling in the parameters ϵ, d, t, and ∥H∥ₘₐₓ, the largest entry of H in absolute value. Additional example implementation details are further described in U.S. Provisional App. No. 63/486,537, incorporated by reference herein.

### Example Quantum Observables

Quantum simulation can include, for example, measuring one or more observables associated with a final state of one or more qubits (e.g., a final state after simulating time evolution of a Hamiltonian). In some instances, the observable can be an observable that encodes one or more properties of the classical physical system. In some instances, the one or more properties can be global properties of the classical physical system as a whole, or aggregated properties associated with a plurality of components (e.g., plurality of generalized oscillating masses 102) of the classical physical system. In some instances, a global property or aggregated property can be a property that cannot be efficiently (e.g., in sublinear time relative to a size of the classical physical system) determined using classical methods.

For example, in some instances, quantum simulation can include measuring an observable encoding a generalized kinetic energy of a plurality of generalized oscillating masses 102. In some instances, the plurality of generalized oscillating masses 102 can comprise all of the generalized oscillating masses 102 of a harmonic approximation of the classical physical system. In some instances, the plurality of generalized oscillating masses 102 can comprise a subset (e.g., strict subset) of the harmonic approximation of the classical physical system.

In some instances, a unitary [symbol] can be provided that flags all generalized oscillating masses 102 of a subset of interest V, by performing the map

[symbol]

|j [symbol] =−1^{v}^{ⱼ}|j [symbol] ,

where vⱼ=−1 if the j^{th} generalized oscillating mass 102 is a member of the subset of interest, and vⱼ=1 if the j^{th} generalized oscillating mass 102 is not a member of the subset of interest. In such instances, a generalized kinetic energy of the subset of interest can be estimated efficiently with a quantum algorithm that makes O(|log δ|/ϵ) uses of the quantum circuits that prepare |ψ/(t) [symbol] and [symbol] |ψ(t) [symbol] , together with their inverses and controlled versions, wherein δ is an error probability and ϵ is an additive error associated with the estimate. For example, the generalized kinetic energy of the subset can be written as

$$\frac{{K}_{V} ( t )}{E} = 〈 ψ ( t ) \vert {P}_{V} \vert ψ ( t ) 〉 ,$$

where Pv=(1− [symbol] )/2 is the projector onto V. Thus, a generalized kinetic energy of a subset of interest V can be determined by estimating [symbol] ψ(t)| [symbol] |ψ(t) [symbol] /2 with additive error ϵ and error probability δ, which is simply the expectation of the unitary [symbol] . Such an observable can be efficiently estimated according to known methods, such as high-confidence amplitude estimation. In this manner, for instance, provided methods can output an estimate of the generalized kinetic energy of a subset of interest within additive error ϵE in time logarithmic with respect to a number N of generalized oscillating masses 102 of the classical physical system. Additional example implementation details are further described in U.S. Provisional App. No. 63/486,537, incorporated by reference herein.

### Example Alternate Quantum States Encoding Classical Physical Properties

Alternative encodings are possible for encoding properties of a classical physical system and simulating the classical physical system using a quantum algorithm (e.g., time evolution of a Hamiltonian).

In one example encoding, an initial state |ψₐₗₜ (0) [symbol] can be initialized based on a normalized state

$$\vert {ψ}_{alt} ( t ) 〉 = \frac{1}{\sqrt{2 X}} ( \begin{matrix}P \vec{y} ( t ) \\ {iB}^{+} P \dot{\vec{y}} ( t )\end{matrix} ) ,$$

where X>0 can be a constant; B⁺ can be the Moore-Penrose pseudo-inverse of B; and P can be a matrix projecting out the components of \vec{y}(t) corresponding to the null space of A (or B^{†}). In other words, P can be the projector onto the subspace orthogonal to the null space of A.

A choice of quantum state encodings can in some instances be associated with computational complexity tradeoffs, and an optimal choice of encoding may depend on a particular use case. For example, encodings using a Moore-Penrose pseudo-inverse can increase a cost of preparing an initial state |ψₐₗₜ(0) [symbol] but can provide more direct access to one or more generalized displacements of one or more generalized oscillating masses 102. In some instances (e.g., simulating a wave equation where A corresponds to a discretized Laplacian), such an increased cost of initial state preparation can dominate a total cost of performing a quantum computation according to provided methods. Additional example implementation details are further described in U.S. Provisional App. No. 63/486,537, incorporated by reference herein.

### Example Mappings for Simulating Universal Quantum Circuits

In some instances, any arbitrary quantum circuit can be mapped to a quantum simulation of the present disclosure. In some instances, this universal mapping can demonstrate that provided systems and methods are BQP-complete. In some instances, a provided quantum simulation can be mapped to a classical physical system (or harmonic approximation thereof) by applying the mappings described herein in a reverse direction. In this manner, for instance, any arbitrary quantum circuit can be mapped to a classical physical system of harmonic oscillators. In some instances, a classical physical system can be simulated (e.g., according to classical methods), and a resulting classical physical state can be mapped to a provided quantum state and then to a final quantum state of the arbitrary quantum circuit. In this manner, for instance, any arbitrary quantum circuit can be simulated using classical methods for simulating harmonic systems.

In some instances, an arbitrary quantum circuit can be mapped to a quantum simulation of the present disclosure by mapping the arbitrary quantum circuit to a plurality of gates from a universal set and mapping the gates from the universal set to a quantum simulation of the present disclosure. A universal set of quantum gates can be, for example, {H, T}, where H can be single-qubit Hadamard gates and T can be three-qubit Toffoli gates. In some instances, a plurality of L gates U_{L} . . . Uₗ operating on n qubits can be mapped to a system of coupled oscillators, where a number of oscillators N can be equal to (L+1)2ⁿ⁺¹; each oscillator can have a generalized mass of 1, such that a matrix of generalized masses M can be equal to [symbol] _{N}, i.e. an N×N diagonal matrix having entries equal to 1; and the matrices A and F, as described above with respect to constructing an appropriate Hamiltonian, can be expressed as

$$A = F = 4 {N}_{} - {\sum }_{l = 1}^{L - 1} ( \vert l 〉 〈 l + 1 \vert + \vert l + 1 〉 〈 l \vert ) ⊗ {W}_{l} , where \\ {W}_{l} = {U}_{l} ⊗ {2}_{}$$

if Uₗ is a Toffoli gate, and Wₗ can be obtained via the mapping

$$\frac{1}{\sqrt{2}} \to ( \begin{matrix}\frac{1}{\sqrt{2}} & 0 \\ 0 & \frac{1}{\sqrt{2}}\end{matrix} ) , - \frac{1}{\sqrt{2}} \to ( \begin{matrix}0 & \frac{1}{\sqrt{2}} \\ \frac{1}{\sqrt{2}} & 0\end{matrix} )$$

if Uₗ is a Hadamard gate. In this manner, for instance, the off-diagonal entries of A can be {0, −1/\sqrt{2}, −1} and the diagonal entries can be 4. In such instances, corresponding off-diagonal entries of a matrix K can be {0, 1/\sqrt{2}, 1}. This can correspond to a 5-sparse system of coupled oscillators where the spring constants are non-negative and can be efficiently accessed based on the equation

$$A = F = 4 {N}_{} - {\sum }_{l = 1}^{L - 1} ( \vert l 〉 〈 l + 1 \vert + \vert l + 1 〉 〈 l \vert ) ⊗ {W}_{l} .$$

In some instances, an initial state of such a 5-sparse system can be \vec{x}(0)=\vec{0}, \vec{\dot{x}}₁ (0)=−\vec{\dot{x}}₂(0)=1, and \vec{\dot{x}}(0)=0 for j>2, so that a total energy E is equal to 1. In such instances, time evolution of a Hamiltonian can be simulated for a time t such that a constant of proportionality can be

$$Ω ( \frac{1}{L} )$$

In such instances, a first generalized kinetic energy of a first plurality of generalized oscillating masses 102 can be obtained, and a second generalized kinetic energy of a second plurality of generalized oscillating masses 102 can be obtained. In some instances, the first and second plurality of generalized oscillating masses 102 can be determined by labelling each oscillator j∈[N] by (l, r), where l∈[L+1] and r=rₙ . . . r₀ in binary (r∈[2ⁿ⁺¹]); defining the first plurality as the set of generalized oscillating masses 102 where l=L+1, r₁=0, and r₀=0; and defining the first plurality as the set of generalized oscillating masses 102 where l=L+1, r₁=1, and r₀=0. In such instances, a difference between the first generalized kinetic energy and the second generalized kinetic energy can be a single-qubit expectation of the arbitrary quantum circuit within additive precision

$$Ω ( \frac{1}{L} )$$

and error probability 1/3. This mapping can, for instance, demonstrate that provided systems and methods are BQP-complete.

Additionally, a 5-sparse system of coupled oscillators mapped in this way can be mapped to a classical physical system (or harmonic approximation thereof) by applying one or more mappings described herein in a reverse direction. In this manner, for instance, an arbitrary quantum circuit can be mapped to a classical physical system of harmonic oscillators. In some instances, a classical physical system can be simulated (e.g., according to classical methods), and a resulting classical physical state can be mapped to a provided quantum state and then to a final quantum state of the arbitrary quantum circuit. In this manner, for instance, an arbitrary quantum circuit can be simulated using classical methods for simulating harmonic systems. Additional example implementation details are further described in U.S. Provisional App. No. 63/486,537, incorporated by reference herein.

### Example Quantum Computing Systems

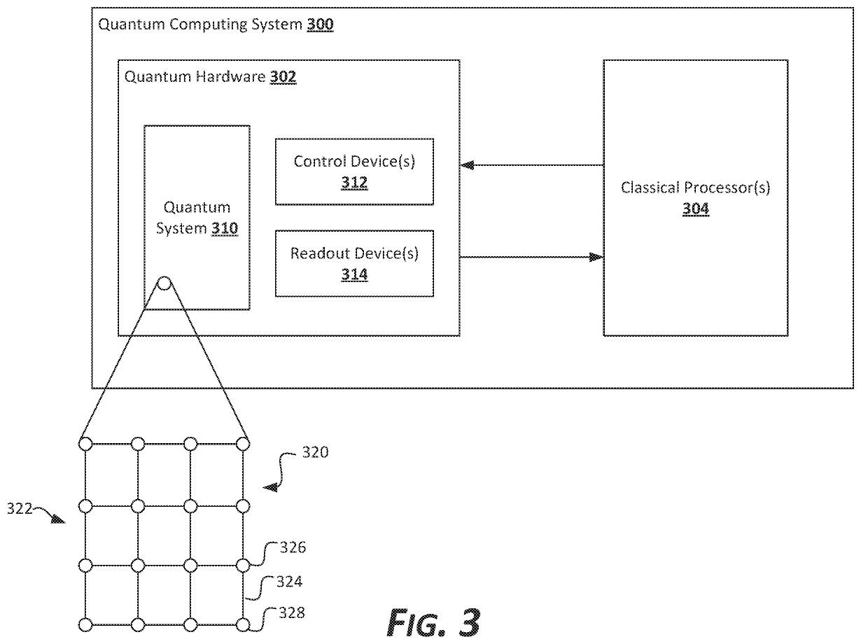

FIG. 3 depicts an example quantum computing system 300. The example system 300 is an example of a system on one or more classical computers or quantum computing devices in one or more locations, in which the systems, components, and techniques described below can be implemented. Those of ordinary skill in the art, using the disclosures provided herein, will understand that other quantum computing structures or systems can be used without deviating from the scope of the present disclosure.

The system 300 includes quantum hardware 302 in data communication with one or more classical processors 304. The quantum hardware 302 includes components for performing quantum computation. For example, the quantum hardware 302 includes a quantum system 310, control device(s) 312, and readout device(s) 314 (e.g., readout resonator(s)). The quantum system 310 can include one or more multi-level quantum subsystems, such as a register of qubits. In some implementations, the multi-level quantum subsystems can include superconducting qubits, such as flux qubits, charge qubits, transmon qubits, gmon qubits, etc.

The type of multi-level quantum subsystems that the system 300 utilizes may vary. For example, in some cases it may be convenient to include one or more readout device(s) 314 attached to one or more superconducting qubits, e.g., transmon, flux, gmon, xmon, or other qubits. In other cases, ion traps, photonic devices or superconducting cavities (e.g., with which states may be prepared without requiring qubits) may be used. Further examples of realizations of multi-level quantum subsystems include fluxmon qubits, silicon quantum dots or phosphorus impurity qubits.

Quantum circuits may be constructed and applied to the register of qubits included in the quantum system 310 via multiple control lines that are coupled to one or more control devices 312. Example control devices 312 that operate on the register of qubits can be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc. The one or more control devices 312 may be configured to operate on the quantum system 310 through one or more respective control parameters (e.g., one or more physical control parameters). For example, in some implementations, the multi-level quantum subsystems may be superconducting qubits and the control devices 312 may be configured to provide control pulses to control lines to generate magnetic fields to adjust the frequency of the qubits.

The quantum hardware 302 may further include readout devices 314 (e.g., readout resonators). Measurement results 308 obtained via measurement devices may be provided to the classical processors 304 for processing and analyzing. In some implementations, the quantum hardware 302 may include a quantum circuit and the control device(s) 312 and readout devices(s) 314 may implement one or more quantum logic gates that operate on the quantum system 302 through physical control parameters (e.g., microwave pulses) that are sent through wires included in the quantum hardware 302. Further examples of control devices include arbitrary waveform generators, wherein a DAC (digital to analog converter) creates the signal.

The readout device(s) 314 may be configured to perform quantum measurements on the quantum system 310 and send measurement results 308 to the classical processors 304. In addition, the quantum hardware 302 may be configured to receive data specifying physical control qubit parameter values 306 from the classical processors 304. The quantum hardware 302 may use the received physical control qubit parameter values 306 to update the action of the control device(s) 312 and readout devices(s) 314 on the quantum system 310. For example, the quantum hardware 302 may receive data specifying new values representing voltage strengths of one or more DACs included in the control devices 312 and may update the action of the DACs on the quantum system 310 accordingly. The classical processors 304 may be configured to initialize the quantum system 310 in an initial quantum state, e.g., by sending data to the quantum hardware 302 specifying an initial set of parameters 306.

The readout device(s) 314 can take advantage of a difference in the impedance for the |0 [symbol] and |1 [symbol] states of an element of the quantum system, such as a qubit, to measure the state of the element (e.g., the qubit). For example, the resonance frequency of a readout resonator can take on different values when a qubit is in the state |0 [symbol] or the state |1 [symbol] , due to the nonlinearity of the qubit. Therefore, a microwave pulse reflected from the readout device 314 carries an amplitude and phase shift that depend on the qubit state. In some implementations, a Purcell filter can be used in conjunction with the readout device(s) 314 to impede microwave propagation at the qubit frequency.

In some implementations, the quantum system 310 can include a plurality of qubits 320 arranged, for instance, in a two-dimensional grid 322. For clarity, the two-dimensional grid 322 depicted in FIG. 1 includes 16 qubits arranged in a square formation, however in some implementations the system 310 may include a smaller or a larger number of qubits. In some embodiments, the multiple qubits 320 can interact with each other through multiple qubit couplers, e.g., qubit coupler 324. The qubit couplers can define nearest neighbor interactions between the multiple qubits 320. In some implementations, the strengths of the multiple qubit couplers are tunable parameters. In some cases, the multiple qubit couplers included in the quantum computing system 300 may be couplers with a fixed coupling strength. In some implementations, the multiple qubits 320 may include data qubits, such as qubit 326 and measurement qubits, such as qubit 328. A data qubit is a qubit that participates in a computation being performed by the system 300. A measurement qubit is a qubit that may be used to determine an outcome of a computation performed by the data qubit. That is, during a computation an unknown state of the data qubit is transferred to the measurement qubit using a suitable physical operation and measured via a suitable measurement operation performed on the measurement qubit.

In some implementations, each qubit in the multiple qubits 320 can be operated using respective operating frequencies, such as an idling frequency and/or an interaction frequency and/or readout frequency and/or reset frequency. The operating frequencies can vary from qubit to qubit. For instance, each qubit may idle at a different operating frequency. The operating frequencies for the qubits 320 can be chosen before a computation is performed by the calibration system. Some operating frequencies are better than other operating frequencies. One metric for assessing how good a particular operating frequency is for a particular qubit is energy relaxation time (T1) for the qubit at the frequency. Lower energy relaxation times can lead to larger quantum computational errors.

In various implementations, the example system 300 can be implemented as a client device, a server device, or both. The example system 300 can be implemented as part of a distributed computing system. The example system 300 can be implemented along with other example systems, which may be the same or different. The example system 300 can be implemented in a server farm or other facility that operates multiple computing systems to provide computational services to or on behalf of a plurality of client systems. Advantageously, techniques according to example aspects of the present disclosure can provide for improved calibration and maintenance of computing facilities, increasing service uptime, decreasing failure rates, etc.

### Example Methods

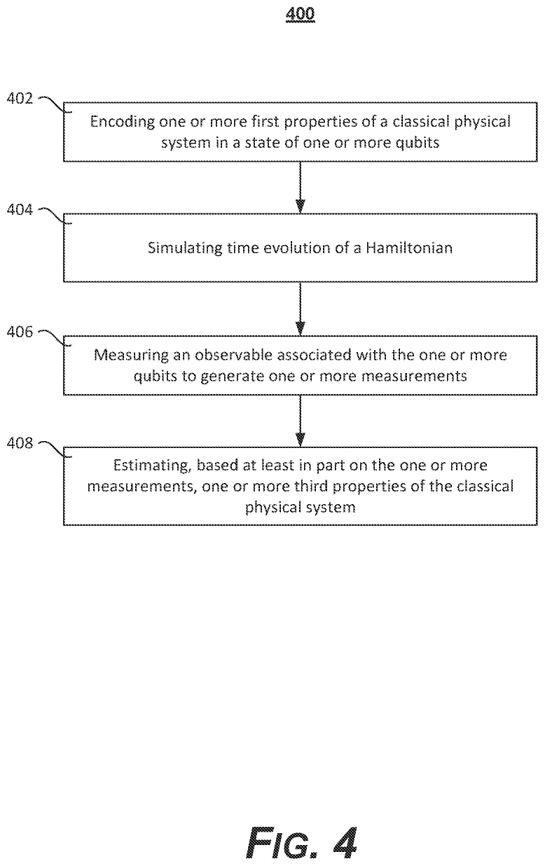

FIG. 4 depicts a flowchart diagram of an example method for simulating a classical physical system according to example embodiments of the present disclosure. Although FIG. 4 depicts steps performed in a particular order for purposes of illustration and discussion, the methods of the present disclosure are not limited to the particularly illustrated order or arrangement. The various steps of example method 400 can be omitted, rearranged, combined, and/or adapted in various ways without deviating from the scope of the present disclosure.

At 402, example method 400 can include encoding one or more first properties of a classical physical system in a state of one or more qubits. In some instances, a first property can be, comprise, correspond to, or otherwise be associated with a generalized property of a generalized oscillating mass 102 or generalized spring 104. In some cases, a first property can be or comprise a generalized momentum, generalized displacement, generalized mass, generalized spring constant, or generalized velocity. In some instances, encoding the first properties can include modeling the classical physical system as a harmonic approximation and encoding properties of the harmonic approximation in the state of the one or more qubits. In some instances, example method 400 at 402 can include using one or more systems or performing one or more activities described with respect to FIGS. 1-3.

At 404, example method 400 can include simulating time evolution of a Hamiltonian, wherein the Hamiltonian is configured so that time evolution of the Hamiltonian corresponds to time evolution of the one or more first properties of the classical physical system. In some instances, a quadrant of a square of the Hamiltonian can comprise a matrix encoding one or more second properties of the classical physical system. In some instances, the matrix encoding the one or more second properties can include a matrix product of a first matrix encoding one or more masses or generalized masses associated with the classical physical system and a second matrix encoding one or more spring constants or generalized spring constants associated with the classical physical system. In some instances, a Hamiltonian can be, comprise, or be comprised by the Hamiltonian H described above. In some instances, simulating the classical physical system can include performing a quantum algorithm having a complexity that is logarithmic with respect to a size of the classical physical system or a size of the harmonic approximation. In some instances, example method 400 at 404 can include using one or more systems or performing one or more activities described with respect to FIGS. 1-3.

At 406, example method 400 can include measuring an observable associated with the one or more qubits to generate one or more measurements. In some instances, an observable can be, comprise, encode, or otherwise correspond to a kinetic energy associated with the classical physical system. In some instances, an observable can be, comprise, encode, or otherwise correspond to a generalized kinetic energy associated with a harmonic approximation of the classical physical system. In some instances, an observable can be, comprise, encode, or otherwise correspond to generalized kinetic energy of a subset of interest of a plurality of generalized oscillating masses 102 associated with a harmonic approximation of the classical physical system. In some instances, example method 400 at 406 can include using one or more systems or performing one or more activities described with respect to FIGS. 1-3.

At 408, example method 400 can include estimating, based at least in part on the one or more measurements, one or more third properties of the classical physical system. In some instances, estimating a third property can be, comprise, or be comprised by high-confidence amplitude estimation. In some instances, example method 400 at 408 can include using one or more systems or performing one or more activities described with respect to FIGS. 1-3.

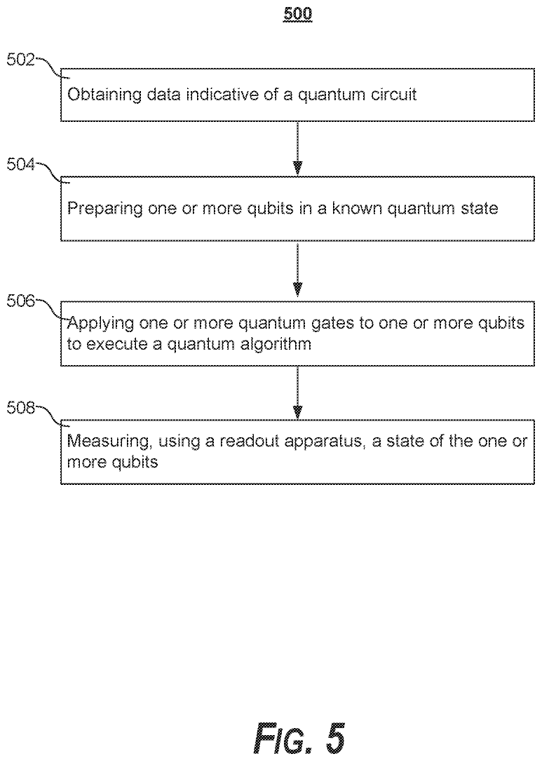

FIG. 5 depicts an example method 500 for performing a quantum computation using a quantum circuit according to example aspects of the present disclosure. For example, a quantum circuit can include, be included in, or be implemented by a quantum system 310 in some instances. Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure. The method 700 can be implemented by any suitable computing system, such as a quantum computing system including quantum hardware in communication with one or more quantum control devices, such as quantum computing system 300 of FIG. 3.

At 502, example method 500 can include obtaining data indicative of a quantum circuit. Obtaining data can include, for example, receiving data from a computing device (e.g. user device, server device); receiving data from a user (e.g. via input/output device); reading data from one or more non-transitory computer-readable media; generating data (e.g. using an algorithm); etc. Data indicative of a quantum circuit can include, for example, a circuit design, circuit diagram, one or more unitary matrices, software code (e.g. quantum software code in a quantum computing language), etc.

At 504, example method 500 can include preparing one or more qubits in a known quantum state. Preparing one or more qubits in a known quantum state can include, for example, preparing one or more qubits in a known basis state (e.g. by manipulating a plurality of qubits such that qubits characterized by a particular basis state, e.g. |0 [symbol] or |1 [symbol] , can be separated from qubits not characterized by that basis state (e.g. physically separated, separately identified, etc.). Preparing one or more qubits in a known quantum state can include, for example, using a control device 312 to perform quantum gating to generate a known multi-qubit basis state. Preparing one or more qubits can include using a control device 312 in a manner described with respect to FIG. 3.

At 506, example method 500 can include applying one or more quantum gates to one or more qubits to execute a quantum algorithm. For example, in some instances control devices 312 can be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc., in a manner described with respect to FIG. 3

At 508, example method 500 can include measuring, using a readout apparatus, a state of at least one of the one or more qubits. The readout apparatus can be, for example, a readout device 314, and step 506 can in some instances be performed in a manner described with respect to FIG. 3.

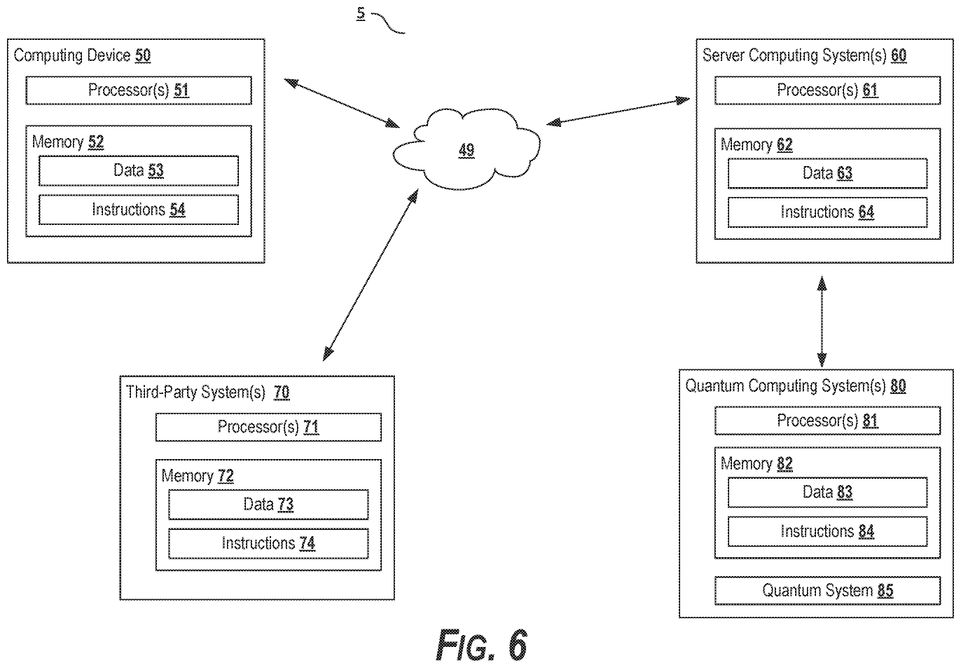

FIG. 6 depicts a block diagram of an example computing system 5 that can perform aspects of example embodiments of the present disclosure. The system 5 includes a computing device 50, a server computing system 60, and a third-party system 70 that are communicatively coupled over a network 49. The system 5 also includes a quantum computing system 80 that is communicatively coupled to the server computing system.

The computing device 50 can be any type of computing device (e.g., classical computing device), such as, for example, a mobile computing device (e.g., smartphone or tablet), a personal computing device (e.g., laptop or desktop), a workstation, a cluster, a gaming console or controller, a wearable computing device, an embedded computing device, or any other type of computing device. In some embodiments, the computing device 50 can be a client computing device or a server computing device. The computing device 50 can include one or more processors 51 and a memory 52. The one or more processors 51 can be any suitable processing device (e.g., a processor core, a microprocessor, an ASIC, an FPGA, a controller, a microcontroller, etc.) and can be one processor or a plurality of processors that are operatively connected. The memory 52 can include one or more non-transitory computer-readable storage media, such as RAM, ROM, EEPROM, EPROM, flash memory devices, magnetic disks, etc., and combinations thereof. The memory 52 can store data 53 and instructions 54 which are executed by the processor 51 to cause the user computing device 50 to perform operations as described herein.

The computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The quantum computing system 80 can include one or more processors 81 (e.g., classical processor(s) 304) and a memory 82. The one or more processors 81 can be any suitable processing device (e.g., a processor core, a microprocessor, an ASIC, an FPGA, a controller, a microcontroller, etc.) and can be one processor or a plurality of processors that are operatively connected. The memory 82 can include one or more non-transitory computer-readable storage media, such as RAM, ROM, EEPROM, EPROM, flash memory devices, magnetic disks, etc., and combinations thereof. The memory 82 can store data 83 and instructions 84 which are executed by the processor 81 to cause the quantum computing system 80 to perform operations as described herein.

The quantum computing system 80 can also include a quantum system 85 for performing quantum computations. In some instances, the quantum system 85 can be, comprise, or be comprised by quantum hardware 302, described above with reference to FIG. 3.

In some implementations, the quantum computing system can 80 include or be otherwise implemented by one or more server computing systems 60. In instances in which the quantum computing system 80 includes plural server computing devices, such server computing devices can operate according to sequential computing architectures, parallel computing architectures, or some combination thereof.

The third-party system 70 can include one or more processors 71 and a memory 72. The one or more processors 71 can be any suitable processing device (e.g., a processor core, a microprocessor, an ASIC, an FPGA, a controller, a microcontroller, etc.) and can be one processor or a plurality of processors that are operatively connected. The memory 72 can include one or more non-transitory computer-readable storage media, such as RAM, ROM, EEPROM, EPROM, flash memory devices, magnetic disks, etc., and combinations thereof. The memory 72 can store data 73 and instructions 74 which are executed by the processor 71 to cause the third-party system 70 to perform operations. In some implementations, the third-party system 70 includes or is otherwise implemented by one or more server computing devices.

The server computing system 60 can include one or more processors 61 and a memory 62. The one or more processors 61 can be any suitable processing device (e.g., a processor core, a microprocessor, an ASIC, an FPGA, a controller, a microcontroller, etc.) and can be one processor or a plurality of processors that are operatively connected. The memory 62 can include one or more non-transitory computer-readable storage media, such as RAM, ROM, EEPROM, EPROM, flash memory devices, magnetic disks, etc., and combinations thereof. The memory 62 can store data 63 and instructions 64 which are executed by the processor 61 to cause the server computing system 60 to perform operations. In some implementations, the server computing system 60 includes or is otherwise implemented by one or more server computing devices.

The network 49 can be any type of communications network (e.g., classical or quantum), such as a local area network (e.g., intranet), wide area network (e.g., Internet), or some combination thereof and can include any number of wired or wireless links. In general, communication over the network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

FIG. 6 illustrates one example computing system that can be used to implement the present disclosure. Other computing systems can be used as well. For example, in some implementations, the quantum computing system 80 can include the server computing system 60 or vice versa. In some implementations, the quantum computing system 80 may be communicatively coupled through the network 49 to the computing device 50, third-party system 70, or server computing system 60.

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital and/or quantum subject matter described in this specification can be implemented as one or more digital and/or quantum computer programs (e.g., one or more modules of digital and/or quantum computer program instructions encoded on a tangible non-transitory storage medium for execution by, or to control the operation of, data processing apparatus). The digital and/or quantum computer storage medium can be a machine-readable storage device, a machine-readable storage substrate, a random or serial access memory device, one or more qubits/qubit structures, or a combination of one or more of them. Alternatively or in addition, the program instructions can be encoded on an artificially-generated propagated signal that is capable of encoding digital and/or quantum information (e.g., a machine-generated electrical, optical, or electromagnetic signal) that is generated to encode digital and/or quantum information for transmission to suitable receiver apparatus for execution by a data processing apparatus.

The terms quantum information and quantum data refer to information or data that is carried by, held, or stored in quantum systems, where the smallest non-trivial system is a qubit (i.e., a system that defines the unit of quantum information). It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states (e.g., qubits) are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, or multiple digital and quantum processors or computers, and combinations thereof. The apparatus can also be, or further include, special purpose logic circuitry, e.g., an FPGA (field programmable gate array), or an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital or classical computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL, Quipper, Cirq, etc. . . .

A digital and/or quantum computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers or processors to be “configured to” or “operable to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum microprocessors or both, or any other kind of central digital and/or quantum processing unit. Generally, a central digital and/or quantum processing unit will receive instructions and digital and/or quantum data from a read-only memory, or a random access memory, or quantum systems suitable for transmitting quantum data, e.g. photons, or combinations thereof.

Some example elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data, e.g., magnetic, magneto-optical disks, or optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more tangible, non-transitory machine-readable storage media, and that are executable on one or more digital and/or quantum processing devices. The systems described in this specification, or portions of them, can each be implemented as an apparatus, method, or electronic system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. Some of the claims are described with a letter reference to a claim element for exemplary illustrated purposes and is not meant to be limiting. The letter references do not imply a particular order of operations. For instance, letter identifiers such as (a), (b), (c), . . . , (i), (ii), (iii), . . . , etc. can be used to illustrate operations. Such identifiers are provided for the ease of the reader and do not denote a particular order of steps or operations. An operation illustrated by a list identifier of (a), (i), etc. can be performed before, after, or in parallel with another operation illustrated by a list identifier of (b), (ii), etc.

What is claimed is:

1. A method for modeling a classical physical system using a quantum computing system, comprising:
encoding one or more first properties of a classical physical system in a state of one or more qubits, the classical physical system comprising an oscillator network; and
simulating, by one or more quantum computing devices using the one or more qubits, the classical physical system.

2. The method of claim 1, wherein the one or more first properties of the classical physical system comprise at least one of:
a generalized momentum associated with at least one oscillator of the oscillator network;
a generalized velocity associated with at least one oscillator of the oscillator network;
a generalized displacement associated with at least one oscillator of the oscillator network; and
a generalized position associated with at least one oscillator of the oscillator network.

3. The method of claim 1, wherein:
simulating the classical physical system comprises performing a quantum computation; and
a complexity of the quantum computation is logarithmic with respect to a size of the classical physical system.

4. The method of claim 1, wherein simulating the classical physical system comprises simulating time evolution of a Hamiltonian.

5. The method of claim 4, wherein the Hamiltonian is configured so that time evolution of the Hamiltonian corresponds to time evolution of the one or more first properties of the classical physical system.

6. The method of claim 4, wherein a square of the Hamiltonian comprises a matrix encoding one or more second properties of the classical physical system.

7. The method of claim 6, wherein the matrix encoding the one or more second properties comprises a matrix product of a first matrix encoding one or more generalized masses associated with the classical physical system and a second matrix encoding one or more generalized spring constants associated with the classical physical system.

8. The method of claim 1, further comprising:
measuring an observable associated with the one or more qubits to generate one or more measurements; and
estimating, based at least in part on the one or more measurements, one or more third properties of the classical physical system.

9. The method of claim 8, wherein the one or more third properties comprise a generalized kinetic energy associated with the classical physical system.

10. The method of claim 1, wherein:
the classical physical system is a first classical physical system;
the first classical physical system is a harmonic approximation of a second classical physical system; and
further comprising:
measuring an observable associated with the one or more qubits to generate one or more measurements; and
estimating, based at least in part on the one or more measurements, one or more third properties of the second classical physical system.

11. The method of claim 10, wherein a harmonic approximation of the one or more third properties corresponds to a generalized kinetic energy of the first classical physical system.

12. A quantum computing system configured to perform operations, the operations comprising:
encoding one or more first properties of a classical physical system in a state of one or more qubits, the classical physical system comprising an oscillator network; and
simulating, by one or more quantum computing devices using the one or more qubits, the classical physical system.

13. The quantum computing system of claim 12, wherein the classical physical system is a harmonic approximation of a second classical physical system.

14. The quantum computing system of claim 12, wherein the one or more first properties of the classical physical system comprise at least one of:
a generalized momentum associated with at least one oscillator of the oscillator network;
a generalized velocity associated with at least one oscillator of the oscillator network;
a generalized displacement associated with at least one oscillator of the oscillator network; and
a generalized position associated with at least one oscillator of the oscillator network.

15. The quantum computing system of claim 12, wherein:
simulating the classical physical system comprises performing a quantum computation; and
a complexity of the quantum computation is logarithmic with respect to a size of the classical physical system.

16. The quantum computing system of claim 12, wherein simulating the classical physical system comprises simulating time evolution of a Hamiltonian.

17. The quantum computing system of claim 16, wherein the Hamiltonian is configured so that time evolution of the Hamiltonian corresponds to time evolution of the one or more first properties of the classical physical system.

18. The quantum computing system of claim 12, further comprising:
measuring an observable associated with the one or more qubits to generate one or more measurements; and
estimating, based at least in part on the one or more measurements, one or more third properties of the classical physical system.

19. The quantum computing system of claim 18, wherein the one or more third properties comprise a generalized kinetic energy associated with the classical physical system.

20. A method for modeling a quantum computing system using a classical computing system, comprising:
mapping, by one or more classical computing devices, a quantum circuit to a classical physical system, the classical physical system comprising an oscillator network;
simulating, by the one or more classical computing devices, the classical physical system; and
determining, by the one or more classical computing devices based on the simulation, a quantum computation result associated with the quantum circuit.
